(19) United States
(12) Patent Application Publication
(10) Pub. No.: US 2025/0087060 A1
(43) Pub. Date: Mar. 13, 2025

(54) METHODS AND SYSTEMS FOR CONTROLLING A CONTINUOUS SYMBOL SEQUENCE MECHANIC USING PERSISTENT AWARD VALUES

(71) Applicant: Aristocrat Technologies, Inc., Las Vegas, NV (US)

(72) Inventors: Gary Penacho, Henderson, NV (US); Allon Englman, Las Vegas, NV (US)

(21) Appl. No.: 18/465,009

(22) Filed: Sep. 11, 2023

(51) Int. Cl. G07F 17/32

(52) U.S. Cl. CPC G07F 17/3267; G07F 17/3213

(57) ABSTRACT

A gaming device including a memory device, and a processor is disclosed. The processor may cause display of a plurality of symbols including at least one symbol displaying a respective credit value thereon during a base game. The processor may, in response to triggering a feature game, determine a plurality of persistent values based at least in part on the at least one respective value symbol displayed in the base game, and cause display of a plurality of credit meters displaying the plurality of persistent values. The processor may generate a continuous symbol sequence by randomly assigning a respective persistent value of the plurality of persistent values to a set of feature symbols included in the continuous symbol sequence, and cause display of the continuous symbol sequence during the feature game including causing display of the set of feature symbols.

### TECHNICAL FIELD

The field of disclosure relates generally to electronic gaming machines, and more specifically, to systems and methods of using a randomly selected award value from accumulated award values to persist during a feature game using a continuous symbol sequence mechanic in a gaming environment.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming device including a memory device storing computer-executable instructions, and a processor is disclosed. The processor may be configured to execute the instructions stored in the memory device, which, when executed, by the processor may cause the processor to: (i) cause display of a plurality of symbols as part of a base game, where each symbol of the plurality of symbols may be displayed within a symbol position of a plurality of symbol positions within a game matrix including rows and columns of symbol positions, and at least one of the plurality of symbols may include at least one respective value symbol displaying a respective credit value thereon; (ii) in response to triggering a feature game, determine a plurality of persistent values for use in the feature game based at least in part on the at least one respective value symbol displayed in the base game; (iii) cause display of a plurality of credit meters in the feature game, where each credit meter of the plurality of credit meters may display one of the plurality of persistent values; (iv) generate a continuous symbol sequence by randomly assigning a respective persistent value of the plurality of persistent values to a set of feature symbols included in the continuous symbol sequence of the feature game; and/or (v) cause display of the continuous symbol sequence during the feature game including causing display of the set of feature symbols.

In another aspect, a computer-implemented method is disclosed. The method may include causing display of a plurality of symbols as part of a base game. Each symbol of the plurality of symbols may be displayed within a symbol position of a plurality of symbol positions within a game matrix. The game matrix may include rows and columns of symbol positions, and at least one of the plurality of symbols may include at least one respective value symbol displaying a respective credit value thereon. The method may include, in response to triggering a feature game, determining a plurality of persistent values for use in the feature game based at least in part on the at least one respective value symbol displayed in the base game, and causing display of a plurality of credit meters in the feature game. Each credit meter of the plurality of credit meters may display one of the plurality of persistent values. The method may include generating a continuous symbol sequence by randomly assigning a respective persistent value of the plurality of persistent values to a set of feature symbols included in the continuous symbol sequence of the feature game and causing display of the continuous symbol sequence during the feature game including causing display of the set of feature symbols.

In yet another aspect, an electronic gaming application server is disclosed. The electronic gaming application server may be communicatively coupled with a gaming device, and may include a memory device storing instructions, at least one random number generator (RNG), and a processor. The processor may be configured to execute the instructions stored in the memory device, which, when executed by the processor, may cause the electronic gaming application server to perform operations comprising: (i) causing display of a plurality of symbols as part of a base game, where each symbol of the plurality of symbols may be displayed within a symbol position of a plurality of symbol positions within a game matrix including rows and columns of symbol positions, and at least one of the plurality of symbols may include at least one respective value symbol displaying a respective credit value thereon; (ii) in response to triggering a feature game, determining a plurality of persistent values for use in the feature game based at least in part on the at least one respective value symbol displayed in the base game; (iii) causing display of a plurality of credit meters in the feature game, where each credit meter of the plurality of credit meters may display one of the plurality of persistent values; (iv) generating a continuous symbol sequence by randomly assigning a respective persistent value of the plurality of persistent values to a set of feature symbols included in the continuous symbol sequence of the feature game; and/or (v) causing display of the continuous symbol sequence during the feature game including causing display of the set of feature symbols.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4F are exemplary screenshots or user interfaces of an electronic gaming machine (EGM) having the continuous symbol sequence mechanic described herein, in accordance with some embodiments of this disclosure.

FIG. 5 illustrates an exemplary flow-chart of method operations performed by an EGM having the continuous symbol sequence mechanic described herein, in accordance with some embodiments of the present disclosure.

### DETAILED DESCRIPTION

Some known electronic gaming machines (EGMs) may use a continuous number sequence mechanic that randomly generates credit (or award) values using, for example, a random number generator (RNG). While randomly generating the credit values for the continuous number sequence mechanic using an RNG, the EGM may further utilize paytables to limit the credit values to a certain range in an attempt to control the return to player (RTP). In other words, the credit values may be randomly generated within specific minimum and maximum credit values. However, in order to do this, these conventional EGMs require additional memory for the paytables and computation resources to randomly generate such a continuous number sequence mechanism, and they do not use persistent credit values to generate a continuous sequence of credit values as described herein.

Various embodiments are described herein to generate a continuous sequence of credit or award values that is based upon persistent credit (or award) values (or credit values generated in accordance with an outcome of a previous game play) while maintaining a designated game RTP. In particular, the EGM and processes described herein include using a continuous sequence of credit (or award) values that are generated or determined from credit (or award) values that are displayed on a given reel of a plurality of reels, during a previous or base game round. Specifically, credit (or award) values that are displayed on a reel during a base game are added (or accumulated) together into a respective reel credit meter for the next round of game play (e.g., a feature game round or a bonus game round). Thus, during the feature or bonus round of the game where the continuous sequence of credit values is enabled and applied, the credit (or award) values that are awarded to the player are randomly selected from the reel credit meters that reflect the accumulated credit (or award) values that were displayed on one or more reels of the plurality of reels.

In some embodiments, a degree of randomness may be maintained, while the continuous sequence of credit values feature is enabled and used, by assigning each reel of the plurality of reels used to form a game play matrix a different range (or a different tier) of credit (or award) values to be displayed. By way of a non-limiting example, the total number of different ranges (or tiers) may include three different ranges (or tiers) such as a low credit value range, a medium credit value range, and/or a high credit value range. Each different range (or tier) may have a respective minimum credit value and a respective maximum credit value. For example, an EGM having a game play matrix of 4×5 with 5 reels (or columns) (reels 1-5) and each reel having 4 rows of game symbol positions being displayed on the EGM display may further include a subset of reels (e.g., reels 2-4, reels 2-3, reels 3-4, or reels 2 and 4) that may be randomly assigned a respective range (or tier) of credit values. For example, reel 2 may be assigned a low credit value range, while reel 3 is assigned a medium credit value range, and reel 4 is assigned a high credit value range. Credit value symbols for each reel of the subset of reels may then have credit values in accordance with the respective range (or tier) of credit values.

As described herein, trigger symbols may include cash-on reel (COR) symbols, a specific animation symbol (e.g., a buffalo, a dragon, an eagle) and so on. In the example embodiment, a credit meter corresponding to each reel of the subset of reels may be displayed, for example, in a display area above each reel of the subset of reels. In some embodiments, all of the reels may be assigned a credit meter. However, in the example embodiment, only the reels of the plurality of reels, having been assigned a randomly selected range (or tier) of credit values, may have a corresponding credit meter. While each reel of the subset of reels may be randomly assigned a range (or tier) of credit values, one or more lookup tables that are weighted may also be assigned to each reel or to a particular range (or tier) of credit values. Thus, a particular reel having a particular range of credit values (low range) assigned to it may also have a set of weighted lookup tables for assigning symbols to the reel. The lookup tables may only include symbols having credit values within that range of credit values. By way of a non-limiting example, a lookup table may be weighted to more likely assign a high credit value range of symbols to reel 4 of reels 1 to 5 in comparison with other reels.

In some embodiments, a continuous sequence of credit values feature may be triggered when a certain condition, for example, a specific trigger symbol or a set of trigger symbols or a certain number of trigger symbols are displayed within a game. By way of a non-limiting example, a continuous sequence of credit values feature may be triggered when a trigger symbol (e.g., a golden buffalo symbol with no credit value associated with it) lands on reel 1 of a 5 reel game (the plurality of reels), and at least one other trigger symbol (e.g., a buffalo symbol with a corresponding credit value) lands on each of reels 2 to 4 (the subset of reels) of the plurality of reels, with another specific trigger symbol (e.g., a dash for cash symbol) landing on reel 5 of the plurality of reels, when the plurality of reels stops spinning. Additionally, or alternatively, a continuous sequence of credit values feature may be triggered when the trigger symbols (e.g., the golden buffalo symbol, one or more of the buffalo symbols with a corresponding credit value, and the other specific trigger symbol) land in a single row or the same row when the plurality of reels stops spinning.

In the example embodiment, upon the triggering of the continuous sequence of credit values feature, an animation is triggered that displays a credit meter corresponding to each reel of the subset of reels. By way of a non-limiting example, the animation to display the credit meters, each credit meter corresponding to each reel of the subset of reels, may be generated and displayed simultaneously. Alternatively, the animation to display the credit meters corresponding to each reel of the subset of reels may be generated and displayed sequentially. The credit meter generated and displayed corresponding to each reel of the subset of reels may also display a total credit value for the credit symbols displayed on the respective reel, which may include the credit values associated with each trigger symbol that lands on the respective reel, when the plurality of reels stops spinning.

In the example embodiment, each credit meter may be displayed as visually distinguishable from each other depending upon the total credit value for the respective reel. By way of an example, a credit meter showing a total credit value that is in a low credit value range may be displayed in bronze color or with a bronze colored halo, a credit meter showing a total credit value that is in a medium credit value range may be displayed in silver color or with a silver colored halo, and a credit meter showing a total credit value that is in a high credit value range may be displayed in golden color or with a golden colored halo. Additionally, or alternative, a total credit value may be displayed using distinguishable text color in accordance with whether the total credit value corresponds with the low credit value range, the medium credit value, or the high credit value range.

In some embodiments, a reel of the plurality of reels may include a special symbol, such as a sunset symbol, and if the sunset symbol is displayed on the reel as the plurality of reels stops spinning, a randomly selected mystery credit value may be displayed on a credit meter associated with the reel on which the sunset symbol landed when the plurality of reels stops spinning. By way of a non-limiting example, the special symbol may also include a Minor Jackpot or a Mini Jackpot on the reel of the plurality of reels when the plurality of reels stops spinning. Further, multipliers from the free games and/or stacked jackpots may also appear after the game is complete.

In some embodiments, a player may be instructed to begin a bonus game or a feature game in which the continuous sequence of credit values feature is enabled. In response to the player's input (e.g., hitting a Play or Spin button) to begin the bonus game or the feature game, the display may be updated to display an animation showing that the continuous sequence of credit values feature has been activated. By way of a non-limiting example, the animation may include a number of buffalos moving across the display, for example, from right-to-left direction. A separate credit meter (for example, a stampede meter or a total award value meter) displaying credit values awarded during the bonus game or the feature game may be displayed. The separate credit meter (or total award value meter) may be referenced herein as a stampede meter as the separate credit meter displays awarded credit values as buffalos stampede from the right-to-left direction. The stampede meter may be displayed, for example, above the individual credit meters corresponding to the subset of reels displayed during the base game play.

In some embodiments, and by way of a non-limiting example, a total number of buffalos that stampede from the right-to-left direction during the bonus game or the feature game may be randomly selected based upon an RNG output. Additionally, or alternatively, the total number of buffalos that stampede from the right-to-left direction may be randomly determined based upon, at least in part, a bet wagered by the player during the base game play and/or a highest credit value awarded to the player on a reel of the subset of reels during the base game play.

As described herein in the example embodiment, for the subset of reels including three reels (e.g., reels 2-4), three separate credit meters showing their respective credit values may be displayed during the bonus game or the feature game. A respective credit value displayed in each credit meter (or a value from the values displayed in the credit meters) may be randomly assigned to at least one or more buffalos stampeding from the right-to-left direction during the bonus game or the feature game. Accordingly, each respective credit value displayed in the credit meters may appear on at least one buffalo stampeding from the right-to-left direction. By way of a non-limiting example, each respective credit value displayed in the credit meters may be overlayed on one or more buffalos which are within a particular number of buffalos stampeding from the right-to-left direction as the bonus game or the feature game begins. Additionally, or alternatively, a respective credit value displayed in at least one credit meter may be randomly assigned to at least one or more buffalos stampeding from the right-to-left direction during the bonus game or the feature game.

In the example embodiment, as the stampeding buffalo reach, for example, near the center of the display device, or above the stampede meter, the credit value displayed as an overlay on the buffalo may be animated to drop from the buffalo into the stampede meter. As the credit value drops into the stampede meter, the dropped credit value may be added to the previously displayed credit value on the stampede meter, and the updated credit value may be displayed on the stampede meter. Additionally, or alternatively, the buffalo with the credit value displayed as an overlay may be displayed as visually distinguishable from other buffalos by animating the same color as the color of the credit meter associated with the credit value overlayed on the stampeding buffalo.

If a Minor Jackpot symbol, or a Mini Jackpot symbol is displayed on a reel of the plurality of reels, during the base game play, as the plurality of reels stopped spinning, the Minor Jackpot symbol or the Mini Jackpot symbol may also be overlayed on at least one buffalo stampeding during the bonus game or the feature game. The stampede meter may be updated in accordance with credit values corresponding to the Mini Jackpot symbol or the Minor Jackpot symbol as the buffalo on which the Mini Jackpot symbol or the Minor Jackpot symbol overlayed passes above the stampede meter. By way of a non-limiting example, the stampede meter may display cumulative credit values awarded during the bonus game or the feature game. Additionally, or alternatively, the stampede meter may display cumulative credit values awarded during the bonus game or the feature game combined with the credit values awarded during the base game play.

In some embodiments, upon completion of the bonus game or the feature game, the animation showing the buffalos stampeding from the right-to-left direction may be stopped. The stampede meter showing the cumulative credit values may be displayed in a larger size and/or may be displayed in a center of the display device of the EGM. Further, a main win meter may be updated based on the credit values awarded to the player during the base game play, and/or the bonus game or the feature game. Depending upon the credit values displayed on the main win meter, a coin shower and/or other celebratory animation may be animated in accordance with the credit values added to the main win meter from the stampede meter. Additionally, or alternative, the coin shower and/or the other celebratory animation may also be accompanied by celebratory sounds.

The EGM, as described herein, thus provides an improvement over known, conventional EGMs in which the bonus game or the feature game employ the continuous sequence of credit values feature. In particular, the improvements over conventional EGMs include conservation of computational resources and memory usage while maintaining variability of game play and RTP by using credit values that are randomly displayed during the base game for later use and display during the feature game.

As described herein, at least one of the technical problems addressed by the systems and processes described herein involve how a gaming device is better able to control credit values that show up in a continuous sequence of credit symbols in a game feature. The continuous symbol sequence mechanic described herein uses persistent credit values generated from reel credit meters. The persistent credit values are credit values that the game generates in a prior round of play. After randomly generating the persistent credit values using reel credit meters, the game subsequently enters a new round of play that has a continuous symbol sequence mechanic. The continuous symbol sequence mechanic randomly generates a sequence of credit values based on one of the persistent credit values. Conventional game features do not include a game processing pipeline that can control and use persistent credit values to generate a continuous sequence of credit values. In addition to generating a continuous sequence of credit values based on persistent credit values, the game system described herein is able to properly provide a degree of randomness to avoid having players detect certain game patterns or behaviors.

The gaming device and processes described herein are technically rooted in gaming technology that generates a continuous sequence of credit values using persistent credit values from one or more reel credit meters. To provide a degree of randomness while also using persistent credit values, the game processing pipeline, described herein and by way of non-limiting example, performs the following:

1. Bronze, Silver, and Gold Buffalo Credit Meters: Reels 2-4 include buffalo symbols with credit values. The game will randomly choose whether each reel or columns (e.g., reels 2-4, or columns 2-4) will generate credit values within certain credit ranges. As an example, the game could have a low credit value range, a medium credit value range, and/or a high credit value range. For a given reel or column, the game randomly establishes a designated credit value range. Based on the designated credit value range, the game randomly determines the credit values for buffalo symbol that land in the game outcome. Reels or columns that are assigned to generate credit values using the higher credit value ranges will have a higher chance of generating credit values used to create a gold buffalo credit meter. To provide a degree of randomness, reels are randomly assigned using higher credit value ranges to generate credit values.

2. Designating Certain Reels to be High Value Reels that have a Higher Likelihood of Landing Higher Credit Symbols: To provide some control while randomly generating credit values, the game can use lookup tables that are weighted to have certain reels utilize higher credit value ranges to generate credit values. As an example, a lookup table could be weighted such that reel 4 is more likely to use the high credit value ranges to generate credit values.

3. Linking the Continuous Symbol Sequence Mechanic with High Value Reels: In an RNG based gaming environment, games cannot implement secondary decisions when generating the game outcome. A secondary decision occurs when a prior game outcome directly impacts a subsequent game outcome. For example, to control the degree of randomness, the game cannot check and determine which reel credit meter has accumulated the highest persistent game value and assign a low probability of randomly choosing the credit value in the next game round. As an example, reel 3's reel credit meter could have the highest credit value (1,000 credits). A game's processing pipeline cannot identify that $1,000 credits is the highest award and assign a relatively low probably of awarding the credit value in the continuous symbol sequence mechanic. Instead, the game weights potentially high value reels to randomly occur less often. There is no guarantee that each time the reel credit meter for the high value reel will have the highest accumulated credit value. In some instances, the high value reels may have low credit values in a certain round of play become of the randomness nature, but on average, such high value reels will often have higher credit values.

4. Guarantee Credit Values on Reel Credit Meters: The game can also reduce the amount of randomness by guaranteeing that at least one persistent credit value from each reel credit meter is awarded in the game feature. To guarantee presenting credit values from each reel credit meter, the game can randomly designate a certain number of continuous credit symbols will include at least one of the credit values shown in each reel credit meter. As an example, the game processing pipeline may determine for the first X number of credit symbols, e.g., 3 credit symbols, will include one of the credit values shown for the 3-reel credit meters. The remaining credit symbols will randomly select the credit values. Thus, each credit value for each reel credit meters are included in the continuous symbol sequence.

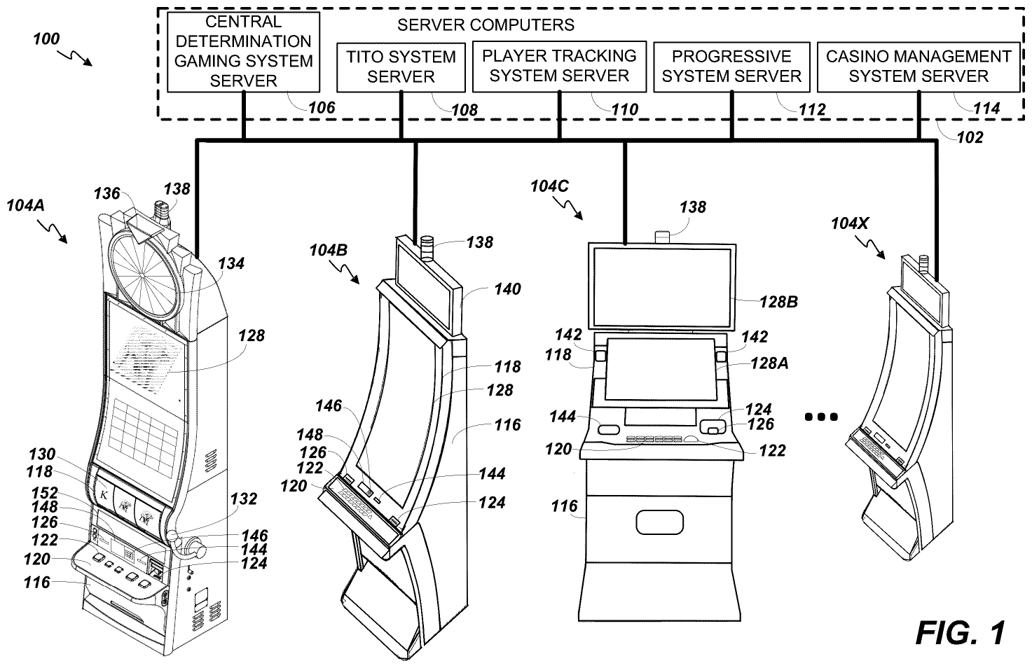

Various exemplary embodiments described herein are discussed below in more detail with respect to FIGS. 1, 2A-2C, 3, 4A-4F, and 5.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

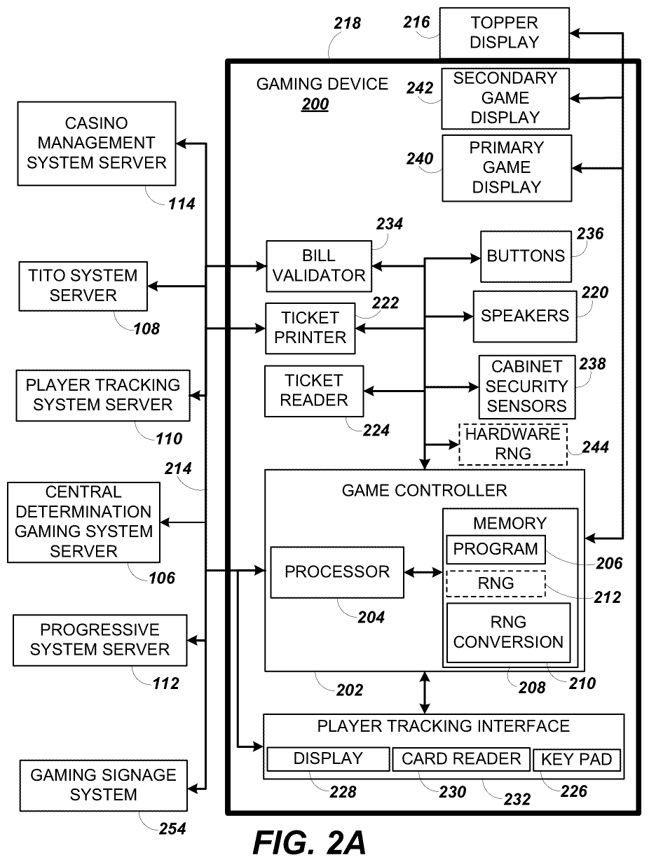

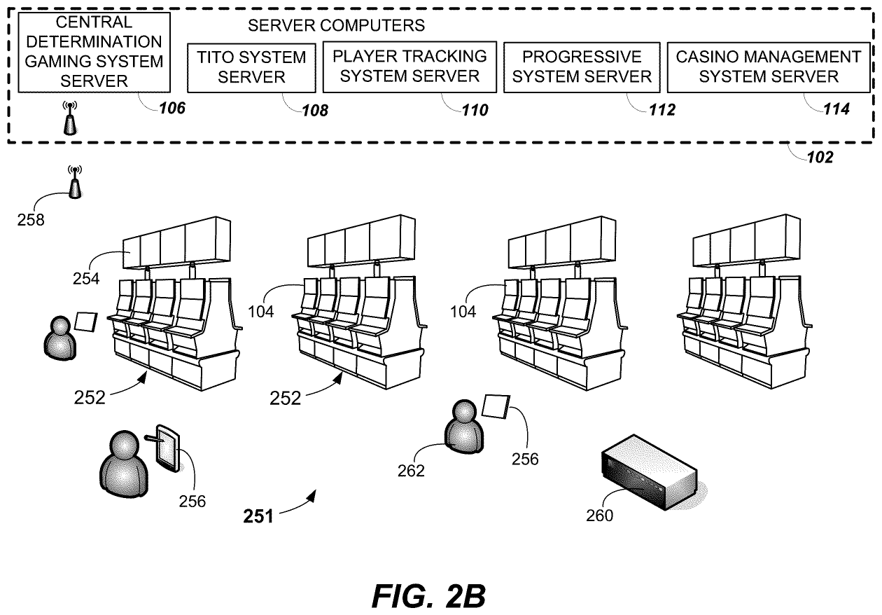

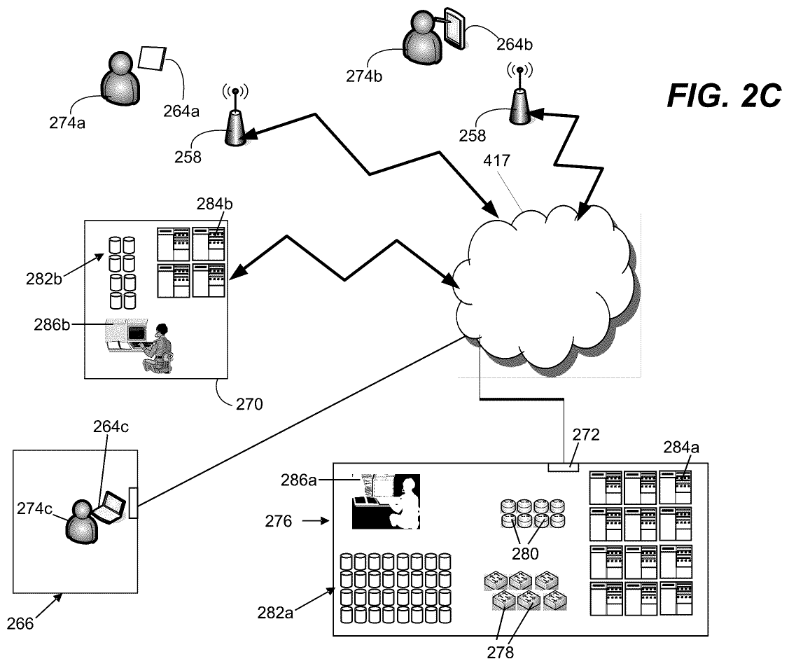

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

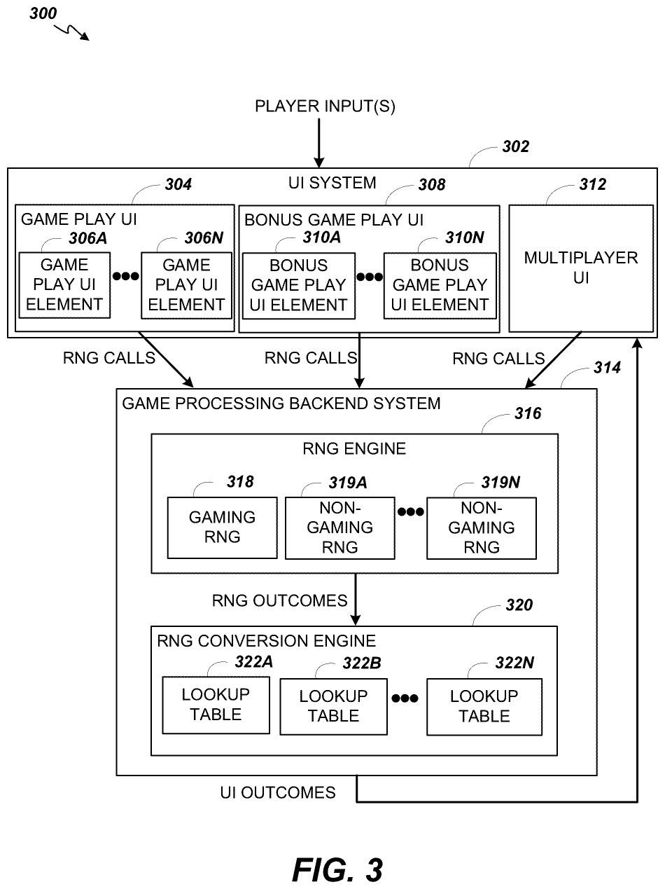

FIG. 3 illustrates, in block diagram form, an implementation of a game processing architecture 300 that implements a game processing pipeline for the play of a game in accordance with various implementations described herein. As shown in FIG. 3, the gaming processing pipeline starts with a UI system 302 receiving one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, or additionally, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

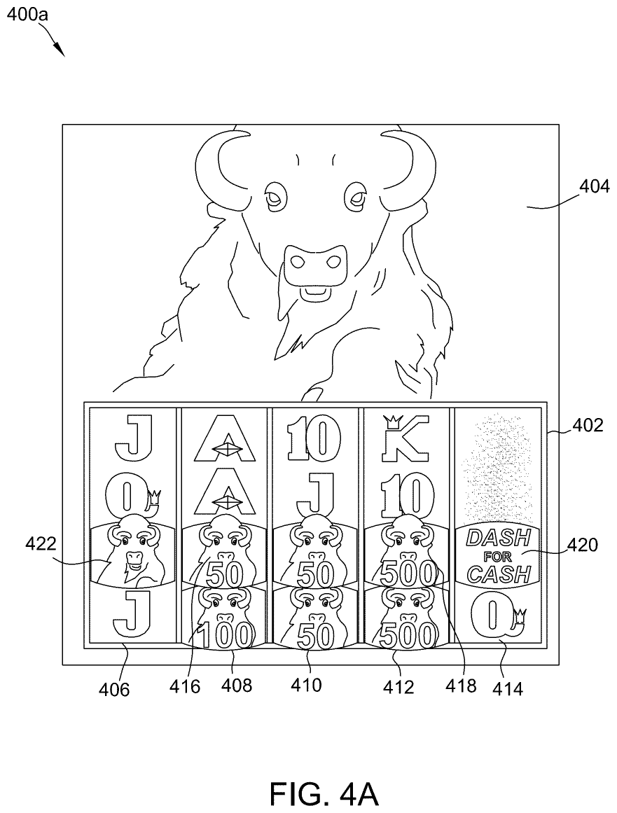

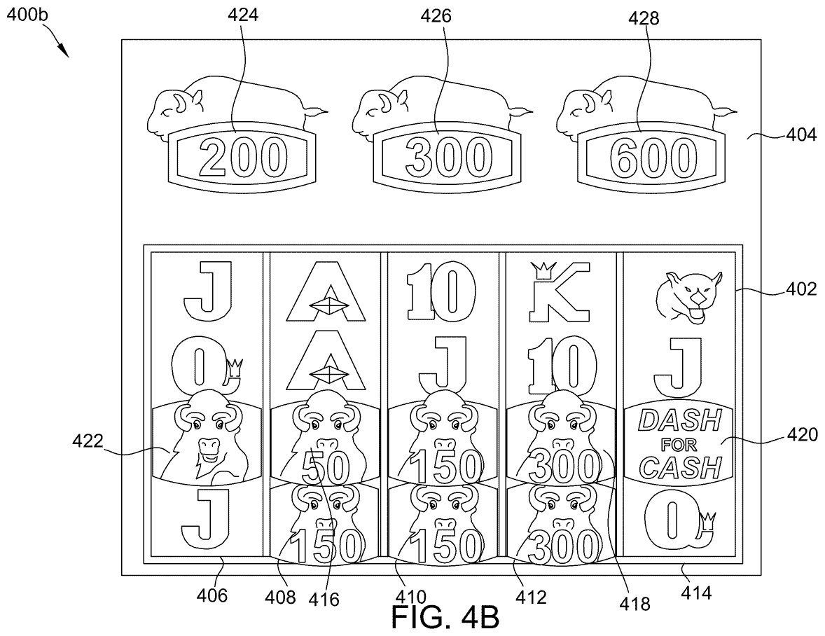

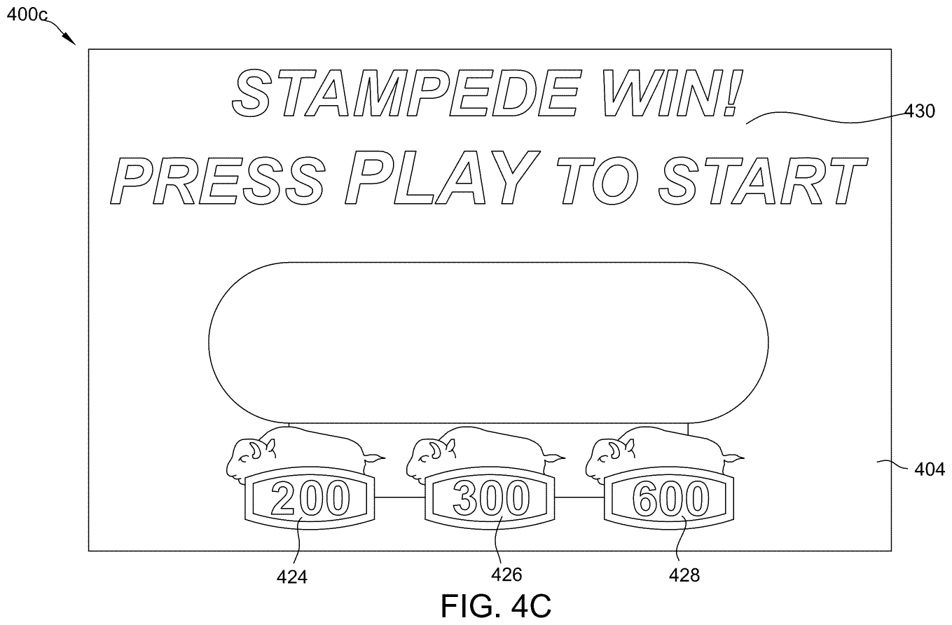

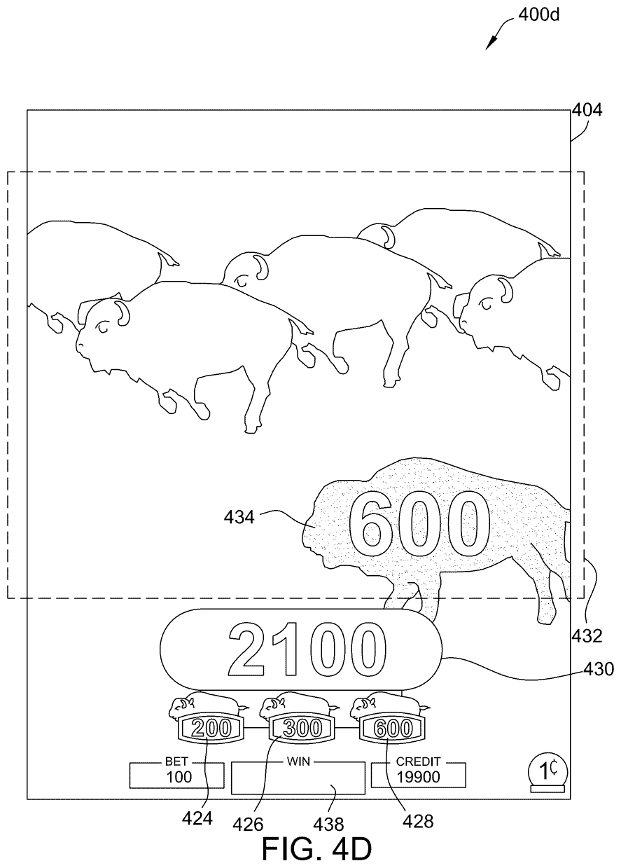

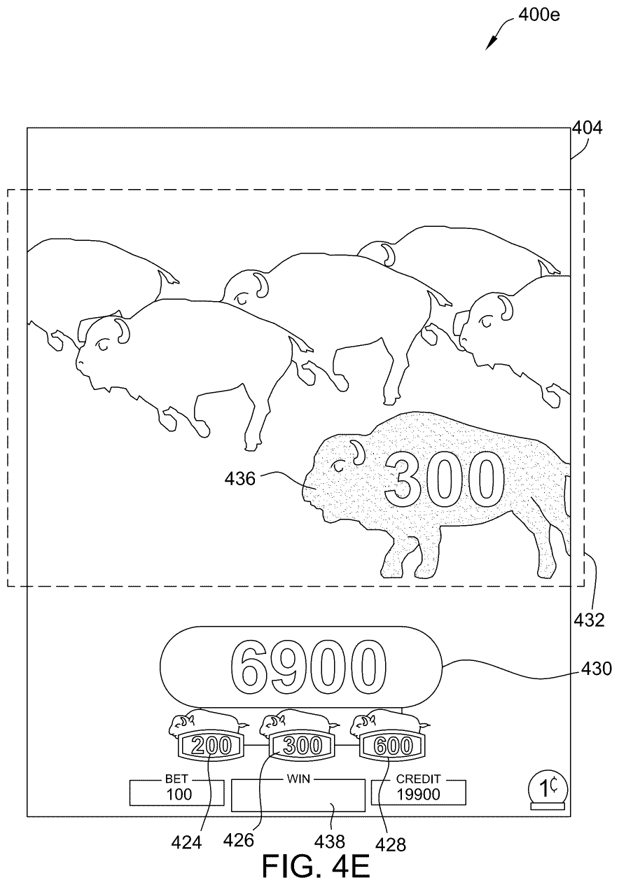

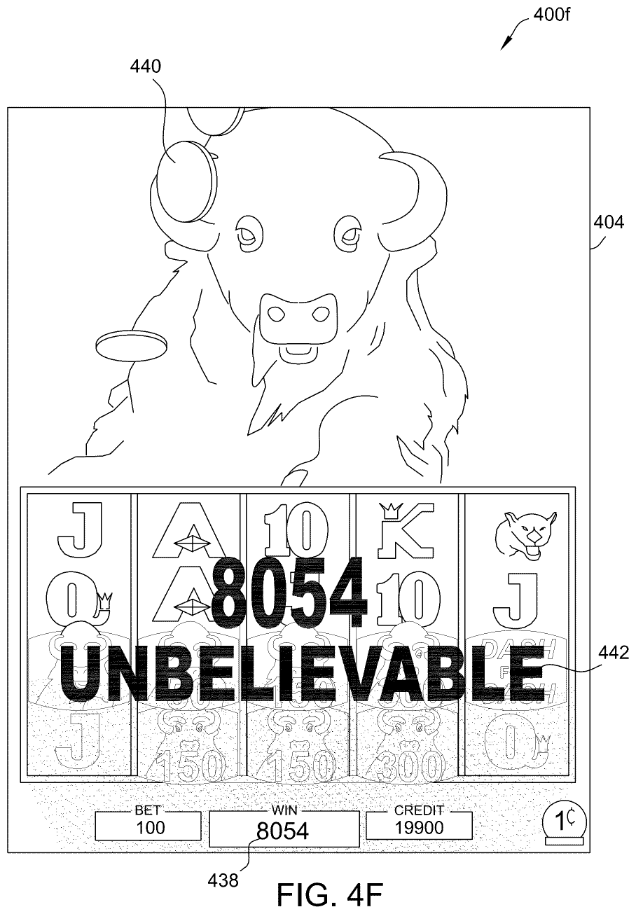

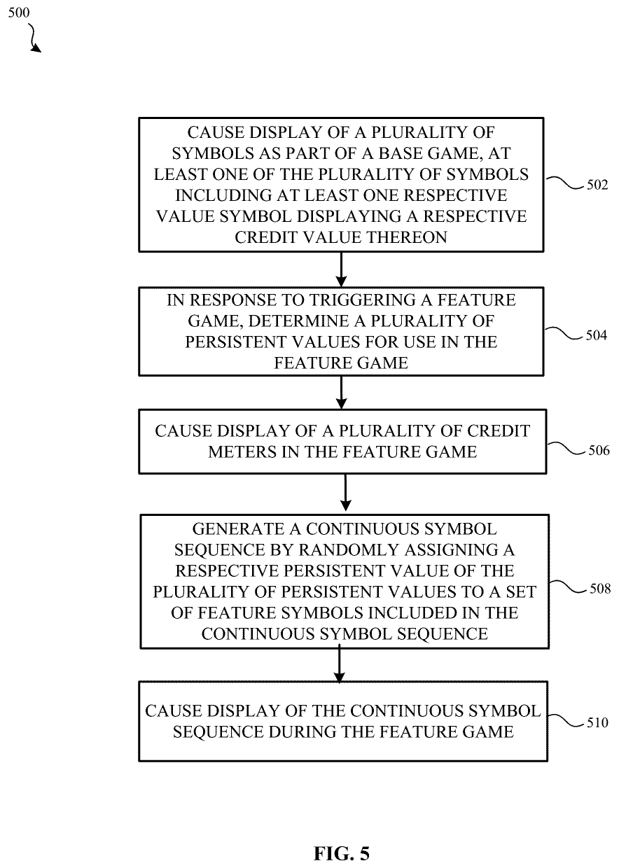

In some embodiments, the UI outcome received by the UI system 302 during the base game, a bonus game, a hold and spin feature, and/or a free game may be triggered. The base game and/or the free game may enable the continuous sequence of credit values feature, as described herein, in more details with respect to FIGS. 4A-4F, and 5.

FIGS. 4A-4F are exemplary screenshots or user interfaces of an EGM or other computing device during a base game play, a bonus game, or a feature game, and/or transition from the base game play to the feature game or the bonus game. The EGM may be configured or adapted to enable the continuous symbol sequence mechanic described herein. In an exemplary screenshot 400a, as shown in FIG. 4A, a display 404 of an EGM may display a game play matrix 402 of a basic game play. The game play matrix 402 may include a plurality of reels and each reel may display game symbols in a specific number of game symbol positions. For example, the game play matrix 402 shown in the view 400a may be a 4×5 game play matrix including 5 reels 406, 408, 410, 412, and 414. Each reel of the plurality of reels 406, 408, 410, 412, and 414 may display 4 game symbols in their respective game symbol positions while the reels 406, 408, 410, 412, and 414 are spinning. When the reels 406, 408, 410, 412, and 414 stop spinning, a bonus game or a feature game may be triggered if a trigger condition is met. By way of a non-limiting example, the trigger condition may include (i) a COR symbol (e.g., symbols 416 and/or 418 showing a credit value overlayed on a buffalo symbol) landing on each of reels 2 through 4 408, 410, and 412; (ii) a trigger symbol, for example, a golden buffalo symbol without any credit value associated with it that is shown as 422, landing on reel 1 406; and (iii) another trigger symbol, for example, a dash for cash symbol 420 landing on reel 5 414. Alternatively, the trigger condition may include at least one COR symbol landing on each of reels 1-3 406, 408, and 410, and the other trigger symbols landing on reels 4 412 and 5 414. Further, even though the trigger symbols are shown as landing on reels 1-5 406, 408, 410, 412, and 414, in a single row, it may not be required that the trigger symbols land in a single row to trigger the bonus game or the feature game.

In another exemplary screenshot 400b, as shown in FIG. 4B, when the bonus game or the feature game is triggered, credit meters 424, 426, and 428 may be generated and displayed on the display 404 of the EGM. Each credit meter of the credit meters 424, 426, and 428, may be displayed above a respective reel on which a COR symbol landed as the reels 406, 408, 410, 412, and 414, stopped spinning. Each credit meter of the credit meters 424, 426, and 428 may display a respective credit value based on cumulative credit values of all COR symbols landed on the particular reel. For example, two COR symbols of values 50 and 150 landed on the reel 408 when the reels 406, 408, 410, 412, and 414, stopped spinning, and, therefore, a credit value of 200 may be displayed on the credit meter 424 associated with the reel 408. Similarly, the credit meter 426 may display a credit value of 300 since two COR symbols and each having a credit value of 150 landed on the reel 410 when the reels 406, 408, 410, 412, and 414 stopped spinning. The credit meter 428 that is associated with the reel 412 may display a credit value of 600 when credit values for the two COR symbols landed on the reel 412 when the reels 406, 408, 410, 412, and 414, stopped spinning gets added or combined.

As described herein, each credit meter of credit meters 424, 426, and 428 may be displayed as visually distinguishable from each other depending upon the total credit value for the respective reel. By way of an example, a credit meter showing a total credit value that is in a low credit value range may be displayed in bronze color or with a bronze colored halo, a credit meter showing a total credit value that is in a medium credit value range may be displayed in silver color or with a silver colored halo, and a credit meter showing a total credit value that is in a high credit value range may be displayed in golden color or with a golden colored halo. Additionally, or alternative, a total credit value may be displayed using distinguishable text color in accordance with whether the total credit value corresponds with the low credit value range, the medium credit value, or the high credit value range.

An exemplary screenshot 400c shown in FIG. 4C may correspond with transitioning from the base game play to the feature game or the bonus game. The player may be instructed to begin the bonus game or the feature game by displaying a message 430 on the display 404 of the EGM. In some examples, the game play matrix area 402 may be removed from displaying on the display 404 during transitioning from the base game play to the feature game or the bonus game, and also during the feature game or the base game.

Exemplary screenshots 400d and 400e shown in FIG. 4D and FIG. 4E, respectively, may be related to the bonus game or the feature game. The credit meters 424, 426, and 428 displaying credit values awarded during the base game play may be displayed such that the player may know that a credit value displayed on each credit meter, or at least one credit meter that is randomly selected, based upon an RNG output, may be awarded during the bonus game or the feature game. A stampede meter 430 may be generated and displayed. As described herein, the stampede meter 430 may be a separate credit meter or a total award value meter displaying the accumulated/aggregated credit values awarded during the bonus game or the feature. During the bonus game or the feature game, if the continuous sequence of credit values feature is enabled, an animation (or a continuous symbol sequence) showing a number of buffalos stampeding from the right-to-left direction may be generated and displayed, which is shown as 432. While each stampeding buffalo may not award a credit value to the player, at least one buffalo stampeding from the right-to-left direction may be overlayed with a credit value that is shown in at least one credit meter (e.g., the credit meter 424, 426, or 428).

As a buffalo 434 overlayed with a credit value passes above the stampede meter 430, the credit value overlayed on the buffalo 434 may be animated to drop from the buffalo 434 into the stampede meter 430, and the credit value shown in the stampede meter 430 may be updated in accordance with the credit value dropped in the stampede meter 430. In some examples, the buffalo 434 overlayed with a credit value may be shown as visually distinguishable from other buffalos. By way of a non-limiting example, the buffalo 434 may be distinguished by having a color that matches with a color of the credit meter showing the credit value overlayed on the buffalo or any other color which is distinguishable from the color of the Buffalos that are not overlayed with a credit value (the Buffalo herd).

Similarly, as a buffalo 436, shown in FIG. 4E, displaying a credit value as an overlay over it passes above the stampede meter 430, the credit value overlayed on the buffalo 436 may be animated to drop from the buffalo 436 into the stampede meter 430, and the credit value shown in the stampede meter 430 may be updated in accordance with the credit value dropped in the stampede meter 430. As described herein, the buffalo 436 overlayed with a credit value may be shown as visually distinguishable from other buffalos. By way of a non-limiting example, the buffalo 436 may be distinguished by having a color that matches with a color of the credit meter showing the credit value overlayed on the buffalo. In the views 400d and 400e, a main win meter 438 is shown without any credit value being displayed in it while the bonus game or the feature game is in progress. However, in some examples, the main win meter 438 may display a total credit value awarded to the player during the base game play combined with the awarded credit value for the in-progress bonus game or the feature game.

As the bonus game or the feature game concludes, an exemplary screenshot shown in FIG. 4F as 400f may be displayed. The main win meter 438 may be updated to display a total credit value awarded to the player based on the credit value awarded during the base game play and the credit value awarded during the bonus game or the feature game. In addition, the base game play matrix 402 may be displayed with an overlay showing an animation 442 in which credit values are increasing at a certain predetermined speed. Additionally, or alternatively, an animation 440 showing a coin shower may be generated and displayed. In some examples, celebratory sound effects may also be played by the EGM in addition to the flashing animation.

FIG. 5 illustrates an exemplary flow-chart 500 of method operations performed by an EGM, in accordance with some embodiments. The method operations may be performed by an EGM. The EGM may include a display device. In some examples, the EGM may include an interface device coupling the EGM with an electronic gaming server. The EGM may also include a memory device that is configured to store instructions, which may be executed by a game controller of the EGM. The game controller may include a processor that is configured to execute the instructions stored in the memory device and/or instructions received from the electronic gaming server. One or more instructions received from the electronic gaming server and/or executed by the EGM may be generated using at least one RNG. By way of a non-limiting example, the EGM may be a user equipment such as a smartphone, a tablet, a laptop, a smart glass, and so on.

The EGM may receive an amount of bet wagered by a player on the EGM. The bet wagered by the player on the EGM may be cash, tokens, and/or credits, and so on. The bet may be wagered by the player in other forms as well. In response to the received amount of bet or wager, and in response to the user input to begin a base game play. During the base game play, a plurality of symbols may be displayed (502) as part of the base game play. Each symbol of the plurality of symbols may be displayed within a symbol position of a plurality of symbol positions within a game matrix. The game matrix may include rows (or a plurality of rows) and columns (or a plurality of columns) of symbols positions. At least one symbol of the plurality of symbols may be a value symbol displaying a respective credit value thereon. For example, the plurality of symbols is displayed in FIG. 4A in rows and columns of the game matrix 402 such that a symbol is displayed in a symbol position of the plurality of symbol positions arranged in rows and columns of the game matrix 402. At least one symbol (e.g., the symbol 416 or the symbol 418) of the plurality of symbols is a value symbol displaying a respective credit value thereon.

In response to a feature game or a bonus game being triggered, a plurality of persistent values for use in the feature game or the bonus game may be determined (504). By way of a non-limiting example, the plurality of persistent values may be determined based at least in part on the at least one value symbol displayed in the base game. At least one persistent value of the plurality of persistent values may be determined as an aggregate of a respective credit value displayed on more than one symbols in symbol positions of a column of the game matrix. For example, as shown in FIG. 4B, the plurality of persistent values includes a first persistent value that is an aggregate of credit values displayed on symbols in symbol positions of the column 408, a second persistent value that is an aggregate of credit values displayed on symbols in symbol positions of the column 410, and a third persistent value that is an aggregate of credit values displayed on symbols in symbol positions of the column 412.

Each persistent value of the plurality of persistent values may be displayed (506) in a credit meter of a plurality of credit meters (e.g., credit meters 424, 426, and/or 428). By way of a non-limiting example, each credit meter of the plurality of credit meters may be displayed in accordance with the respective persistent value for each credit meter, or a credit value range associated with the respective persistent value. Each credit meter of the plurality of credit meters may correspond with a different column of the columns of the game matrix, where each column may be randomly assigned a credit value range of a plurality of credit value ranges. The plurality of credit value ranges may include a first credit value range (or a low credit value range), a second credit value range (or a medium credit value), and a third credit value range (or a high credit value range). A particular column of the columns of the game matrix may be weighted to be assigned to a specific credit value range of the plurality of credit value ranges.

A continuous symbol sequence (shown as 432 in FIG. 4D) including a set of feature symbols (shown in FIG. 4D and FIG. 4E as 434 and 436, respectively) and other symbols may be generated (508). Each feature symbol of the set of feature symbols may be randomly assigned a respective persistent value of the plurality of persistent values (or a value equivalent to the randomly selected persistent value of the plurality of persistent values multiplied by a randomly selected multiplier value). During the feature game, the continuous symbol sequence including the set of feature symbols and other symbols may be displayed (510).

Accordingly, various embodiments, as described herein, may provide an improvement over the conventional EGM in which the bonus game or the feature game employs the continuous sequence of credit values feature. In particular, the improvement over the conventional EGM is provided as the credit value for at least one symbol during the feature game is in accordance with a persistent credit value displayed in each credit meter during the base game play.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A gaming device, comprising:
a memory device storing computer-executable instructions; and
a processor, wherein execution of the instructions by the processor causes the processor to:
cause display of a plurality of symbols as part of a base game, each symbol of the plurality of symbols displayed within a symbol position of a plurality of symbol positions within a game matrix, the game matrix including rows and columns of symbol positions, at least one of the plurality of symbols including at least one respective value symbol displaying a respective credit value thereon;
in response to triggering a feature game, determine a plurality of persistent values for use in the feature game based at least in part on the at least one respective value symbol displayed in the base game;
cause display of a plurality of credit meters in the feature game, each credit meter of the plurality of credit meters displaying one of the plurality of persistent values;
generate a continuous symbol sequence by randomly assigning a respective persistent value of the plurality of persistent values to a set of feature symbols included in the continuous symbol sequence of the feature game; and
cause display of the continuous symbol sequence during the feature game including causing display of the set of feature symbols.

2. The gaming device of claim 1, wherein at least one persistent value of the plurality of persistent values is an aggregate of respective credit value symbols displayed within multiple symbol positions of a column of the game matrix.

3. The gaming device of claim 1, wherein each credit meter of the plurality of credit meters is assigned a different respective range of values that the respective persistent value is included within.

4. The gaming device of claim 1, wherein
each credit meter of the plurality of credit meters is associated with a different column of the columns of the game matrix, wherein the persistent value displayed within each credit meter of the plurality of credit meters is an aggregate of the respective value symbols displayed within the column associated with the respective credit meter.

5. The gaming device of claim 4, wherein
the plurality of credit meters includes a first credit meter having a first credit value range assigned thereto, a second credit meter having a second credit value range assigned thereto, and a third credit meter having a third credit value range assigned thereto, and wherein the third credit value range is greater than the second credit value range, and the second credit value range is greater than the first credit value range.

6. The gaming device of claim 1, wherein a number of feature symbols included in the set of feature symbols is determined at least in part by the processor and an output from a random number generator (RNG).

7. The gaming device of claim 1, wherein the continuous symbol sequence includes the set of feature symbols and other symbols that are animated to move across a display device in a specific direction.

8. The gaming device of claim 7, wherein the respective persistent values assigned to each feature symbol of the set of feature symbols is determine by the processor and an output from an RNG.

9. The gaming device of claim 1, wherein each feature symbol of the set of feature symbols included in the continuous symbol sequence is displayed as visually distinguishable in accordance with the respective persistent value of each feature symbol.

10. The gaming device of claim 1, wherein the respective persistent value displayed on a feature symbol of the set of feature symbols included in the continuous symbol sequence is animated as dropping from the feature symbol into a stampede meter as the feature symbol move across a display device and over the stampede meter.

11. A computer-implemented method, comprising:
causing display of a plurality of symbols as part of a base game, each symbol of the plurality of symbols displayed within a symbol position of a plurality of symbol positions within a game matrix, the game matrix including rows and columns of symbol positions, at least one of the plurality of symbols including at least one respective value symbol displaying a respective credit value thereon;
in response to triggering a feature game, determining a plurality of persistent values for use in the feature game based at least in part on the at least one respective value symbol displayed in the base game;
causing display of a plurality of credit meters in the feature game, each credit meter of the plurality of credit meters displaying one of the plurality of persistent values;
generating a continuous symbol sequence by randomly assigning a respective persistent value of the plurality of persistent values to a set of feature symbols included in the continuous symbol sequence of the feature game; and
causing display of the continuous symbol sequence during the feature game including causing display of the set of feature symbols.

12. The computer-implemented method of claim 11, wherein the determining the plurality of persistent values further comprises determining at least one persistent value of the plurality of persistent values as an aggregate of respective credit value symbols displayed within multiple symbol positions of a column of the game matrix.

13. The computer-implemented method of claim 11, further comprising assigning each credit meter of the plurality of credit meters a different respective range of values that the respective persistent value is included within.

14. The computer-implemented method of claim 11, wherein:
each credit meter of the plurality of credit meters is associated with a different column of the columns of the game matrix, wherein the persistent value displayed within each credit meter of the plurality of credit meters is an aggregate of the respective value symbols displayed within the column associated with the respective credit meter; and
the plurality of credit meters includes a first credit meter having a first credit value range assigned thereto, a second credit meter having a second credit value range assigned thereto, and a third credit meter having a third credit value range assigned thereto, and wherein the third credit value range is greater than the second credit value range, and the second credit value range is greater than the first credit value range.

15. The computer-implemented method of claim 11, wherein a number of feature symbols included in the set of feature symbols is determine at least in part based on an output from a random number generator (RNG).

16. The computer-implemented method of claim 11, further comprising animating the set of feature symbols and other symbols included in the continuous symbol sequence to move across a display device in a specific direction.

17. The computer-implemented method of claim 11, wherein the causing display of the continuous symbol sequence further comprises displaying each feature symbol of the set of feature symbols included in the continuous symbol sequence as visually distinguishable in accordance with the respective persistent value of each feature symbol.

18. The computer-implemented method of claim 11, further comprising animating the respective persistent value displayed on a feature symbol of the set of feature symbols included in the continuous symbol sequence as dropping from the feature symbol into a stampede meter as the feature symbol move across a display device and over the stampede meter.

19. An electronic gaming application server communicatively coupled with a gaming device, the electronic gaming application server comprising:
a memory device storing instructions; and
a processor configured to execute the instructions stored in the memory device, which, when executed, cause the electronic gaming application server to perform operations comprising:
causing display of a plurality of symbols as part of a base game, each symbol of the plurality of symbols displayed within a symbol position of a plurality of symbol positions within a game matrix, the game matrix including rows and columns of symbol positions, at least one of the plurality of symbols including at least one respective value symbol displaying a respective credit value thereon;
in response to triggering a feature game, determining a plurality of persistent values for use in the feature game based at least in part on the at least one respective value symbol displayed in the base game;
causing display of a plurality of credit meters in the feature game, each credit meter of the plurality of credit meters displaying one of the plurality of persistent values;
generating a continuous symbol sequence by randomly assigning a respective persistent value of the plurality of persistent values to a set of feature symbols included in the continuous symbol sequence of the feature game; and
causing display of the continuous symbol sequence during the feature game including causing display of the set of feature symbols.

20. The electronic gaming application server of claim 19, wherein the determining the plurality of persistent values further comprises determining at least one persistent value of the plurality of persistent values as an aggregate of respective credit value symbols displayed within multiple symbol positions of a column of the game matrix.
